(19) United States
(12) Patent Application Publication
(10) Pub. No.: US 2012/0099246 A1
(43) Pub. Date: Apr. 26, 2012

(54) LITHIUM ION CAPACITOR

(75) Inventors: Ji Sung Cho, Gyeonggi-do (KR); Sang Kyun Lee, Gyeonggi-do (KR); Bae Kyun Kim, Gyeonggi-do (KR)

(73) Assignee: SAMSUNG ELECTRO-MECHANICS CO., LTD.

(21) Appl. No.: 13/220,011

(22) Filed: Aug. 29, 2011

(30) Foreign Application Priority Data
Oct. 21, 2010 (KR) 10-2010-0102786

(51) Int. Cl. H01G 9/035

(52) U.S. Cl. 361/505

(57) ABSTRACT

Disclosed herein is a lithium ion capacitor, including: a positive electrode including a positive electrode activated material; a negative electrode including a negative electrode activated material; and an electrolyte disposed between the positive and negative electrodes, wherein the positive electrode activated material includes a mixture of lithium iron phosphate (LiFePO4) and activated carbon, thereby having improved energy density and capacitance and a long life span.

### CROSS REFERENCE(S) TO RELATED APPLICATIONS

This application claims the benefit under 35 U.S.C. Section 119 of Korean Patent Application Serial No. 10-2010-0102786, entitled “Lithium Ion Capacitor” filed on Oct. 21, 2010, which is hereby incorporated by reference in its entirety into this application.

### BACKGROUND OF THE INVENTION

1. Technical Field

The present invention relates to a lithium ion capacitor, and more particularly, to a lithium ion capacitor in which energy density and capacitance characteristics are improved using lithium iron phosphate.

2. Description of the Related Art

A stable supply of energy has been an important factor in various electronic products such as information communication devices. Generally, such a function is performed by a capacitor. In other words, the capacitor serves to store and supply electricity in circuits of information communication devices and various electronic products, thereby stabilizing a flow of electricity in the circuits. A general capacitor has a very short charging/discharging time, a long life span, and a high output density, but has low energy density, thereby having a limitation in being used as a storage apparatus.

Meanwhile, an apparatus referred to as an ultracapacitor or a supercapacitor has been spotlighted as the next-generation storage apparatus due to rapid charging/discharging speed, high stability, and environment-friendly characteristics.

A general supercapacitor is configured of an electrode structure, a separator, an electrolyte solution, and the like. The supercapacitor is driven based on an electrochemical reaction mechanism that carrier ions in the electrolyte solution are selectively adsorbed to the electrode by applying power to the electrode structure. As representative supercapacitors, an electric double layer capacitor (EDLC), a pseudocapacitor, a hybrid capacitor, and the like are currently used.

The electric double layer capacitor is a supercapacitor which uses an electrode made of activated carbon and uses an electric double layer charging as a reaction mechanism. The pseudocapacitor is a supercapacitor which uses a transition metal oxide or a conductive polymer as an electrode and uses pseudo-capacitance as a reaction mechanism. The hybrid capacitor is a supercapacitor having intermediate characteristics between the electric double layer capacitor and the pseudocapacitor.

As the hybrid capacitor, a lithium ion capacitor (LIC), which uses a positive electrode made of activated carbon and a negative electrode made of graphite and use lithium ions as carrier ions to have high energy density of a secondary battery and high output characteristics of the electric double layer capacitor, has been spotlighted.

The lithium ion capacitor contacts negative electrode material capable of absorbing and separating the lithium ions to a lithium metal and previously absorbs or dopes the lithium ions to the negative electrode using a chemical method or an electrochemical method, thereby lowering the potential of the negative electrode to increase withstanding voltage and significantly improving energy density.

Meanwhile, lithium iron phosphate (LiFePO4) has characteristics in which it does not discharge oxygen even in a high-temperature state of 400° C. and has high stability, a strong crystal structure and long life span. Due to these characteristics, research into using the lithium iron phosphate as a positive electrode material of a middle or large-sized capacitor such as power storage in a power plant, or the like or a positive electrode material of lithium ion secondary battery or electric double layer capacitor have been continuously conducted.

However, since the lithium iron phosphate has low conductivity and large resistance, when energy storage apparatuses according to the related art, including the lithium iron phosphate, are continuously used, they are deteriorated while the temperature rises, such that the life span is reduced. Particularly, the lithium ion secondary battery including the lithium iron phosphate may not be stably driven due to destruction of a coating on the surface of a negative electrode.

### SUMMARY OF THE INVENTION

An object of the present invention is to provide a stable and a large-capacitance lithium ion capacitor using lithium iron phosphate as a positive electrode material and solving a problem due to high resistance of the lithium iron phosphate, thereby having long life span and excellent reliability while implementing high energy density.

According to an exemplary embodiment of the present invention, there is a lithium ion capacitor, including: a positive electrode including a positive electrode activated material; a negative electrode including a negative electrode activated material; and an electrolyte disposed between the positive and negative electrodes, wherein the positive electrode activated material includes a mixture of lithium iron phosphate (LiFePO4) and activated carbon.

The content of the activated carbon of the positive electrode activated material may be 30 wt % to 60 wt %.

The negative electrode may include carbon materials pre-doped with lithium ions.

The doping amount of the lithium ions may be 80 to 95% of the capacitance of the negative electrode.

The positive electrode activated material and the negative electrode activated material may be materials capable of being reversibly doped/dedoped with the lithium ions or anions.

### DESCRIPTION OF THE PREFERRED EMBODIMENTS

Various advantages and features of the present invention and methods accomplishing thereof will become apparent from the following description of embodiments with reference to the accompanying drawings. However, the present invention may be modified in many different forms and it should not be limited to the embodiments set forth herein. These embodiments may be provided so that this disclosure will be thorough and complete, and will fully convey the scope of the invention to those skilled in the art.

Terms used in the present specification are for explaining the embodiments rather than limiting the present invention. Unless explicitly described to the contrary, a singular form includes a plural form in the present specification. The word “comprise” and variations such as “comprises” or “comprising,” will be understood to imply the inclusion of stated constituents, steps, operations and/or elements but not the exclusion of any other constituents, steps, operations and/or elements.

Hereinafter, a configuration of lithium ion capacitor according to an exemplary embodiment of the present invention will be described in detail.

In the present invention, lithium oxide having high capacitance is included as a positive electrode activated material in order to improve energy density of a lithium ion capacitor.

Meanwhile, the lithium oxide has high capacitance; however, it also has high resistance, which causes several problems. Therefore, in the present invention, lithium iron phosphate is not singly used as a positive electrode activated material of the lithium ion capacitor, but lithium iron phosphate is mixed with a predetermined amount of activated carbon to lower resistance of the positive electrode and improve the life span characteristics.

At this time, the ratio of the activated carbon of a positive electrode activated material is preferably in the range of 30 wt % to 60 wt %.

When the content of the activated carbon is below 30 wt %, deterioration of the capacitor is intensified after continuous repetition of the charging/discharging operation of the lithium ion capacitor due to high resistance of the lithium iron phosphate, such that the life span of the capacitor is shortened.

In addition, when the content of the activated carbon is over 60 wt %, reaction of the lithium iron phosphate to various ions contained in an electrolyte solution on a surface of the positive electrode is weakened, such that the energy density and the capacitance of the lithium ion capacitor are not improved.

According to an exemplary embodiment of the present invention, a mixture of the lithium iron phosphate and the activated carbon is used as the positive electrode activated material and a carbon material pre-doped with lithium ions is used as a negative electrode activated material.

Hereinafter, a specific configuration according to an exemplary embodiment of the present invention will be described in detail with reference to experimental examples.

### [Manufacturing Positive Electrode]

A mixture of lithium iron phosphate and activated carbon in the ratio of 7:3 was used as a positive electrode activated material, and the positive electrode activated material, acetylene black and polyvinyliden fluoride were each mixed in the weight ratio of 8:1:1.

Next, the mixture was added to N-methypyrrolidone, which is a solvent, and was agitated to make slurry. Then, the slurry was applied on an aluminum foil having a thickness of 20 μm using a doctor blade method, was primarily dried and then, was cut in a predetermined size (for example, 100×100 mm). At this time, a thickness of the electrode was about 50 μm, and the slurry was dried at 120° C. for ten hours under a vacuum before cell assembling.

### [Manufacturing Negative Electrode]

Graphite as a negative electrode activated material, acetylene black and polyvinyliden fluoride were mixed in the weight ratio of 8:1:1. Next, the mixture was added to N-methypyrrolidone, which is a solvent, and was agitated to make slurry. Then, the slurry was applied on a copper foil having a thickness of 10 μm using a doctor blade method, was semi-dried and then, was cut in a predetermined size. At this time, a thickness of the electrode was about 30 μm, and the slurry was dried at 120° C. for five hours under a vacuum before cell assembling.

### [Preparing Electrolyte Solution]

An electrolyte solution was prepared by dissolving LiPF6 at a density of 1.2 mol/L using a mixture of ethylene carbonate (EC), propylene carbonate (PC), and ethyl methyl carbonate (EMC) mixed in the weight ratio of 3:1:2 as a solvent.

### [Pre-Doping Negative Electrode]

The negative electrode and a lithium metal foil were in contact with each other to be opposite to each other, having a polypropylene nonwoven as a separator therebetween, to be doped with the lithium ions. The doping of the lithium ions continued for about two hours to make the doping amount of the lithium ions reached about 85% of the capacitance of the negative electrode.

### [Assembling Capacitor Cell]

The separator was inserted between the prepared positive and negative electrodes to manufacture a stacked cell. Then, the cell was sealed in the form of being impregnated together with the electrolyte solution in a pouch-shaped case and was left for twenty four hours.

The capacitor prepared as described above was charged up to 3.8 V with a constant current—a constant voltage within a constant temperature bath of 25° C. for 900 seconds and then was discharged up to 2.0V with a constant voltage to calculate the capacitance.

At this time, the calculated capacitance of the lithium ion capacitor was 65 Wh/kg.

According to the exemplary embodiment of the present invention, it is possible to implement the lithium ion capacitor capable of being stably used for a long time by solving a problem due to high resistance of the lithium iron phosphate, while having greatly improved capacitance as compared to the capacitor, according to the related art using only the activated carbon as the negative electrode.

In addition, the present invention may manufacture an ultra-capacitance lithium ion capacitor for photovoltaic power generation and wind power generation.

The present invention has been described in connection with what is presently considered to be practical exemplary embodiments. Although the exemplary embodiments of the present invention have been described, the present invention may also be used in various other combinations, modifications and environments. In other words, the present invention may be changed or modified within the range of concept of the invention disclosed in the specification, the range equivalent to the disclosure and/or the range of the technology or knowledge in the field to which the present invention pertains. The exemplary embodiments described above have been provided to explain the best state in carrying out the present invention. Therefore, they may be carried out in other states known to the field to which the present invention pertains in using other inventions such as the present invention and also be modified in various forms required in specific application fields and usages of the invention. Therefore, it is to be understood that the invention is not limited to the disclosed embodiments. It is to be understood that other embodiments are also included within the spirit and scope of the appended claims.

What is claimed is:

1. A lithium ion capacitor, comprising:
a positive electrode including a positive electrode activated material;
a negative electrode including a negative electrode activated material; and
an electrolyte disposed between the positive and negative electrodes,
wherein the positive electrode activated material includes a mixture of lithium iron phosphate (LiFePO4) and activated carbon.

2. The lithium ion capacitor according to claim 1, wherein the content of the activated carbon of the positive electrode activated material is 30 wt % to 60 wt %.

3. The lithium ion capacitor according to claim 1, wherein the negative electrode includes carbon materials pre-doped with lithium ions.

4. The lithium ion capacitor according to claim 3, wherein the doping amount of the lithium ions is 80 to 95% of the capacitance of the negative electrode.

5. The lithium ion capacitor according to any one of claims 1 to 4, wherein the positive electrode activated material and the negative electrode activated material are materials capable of being reversibly doped/dedoped with respect to the lithium ions or anions.
